(19) United States
(12) Patent Application Publication
(10) Pub. No.: US 2009/0076908 A1
(43) Pub. Date: Mar. 19, 2009

(54) USER GENERATION OF KEYWORDS FOR CONTENT AUTHORED BY THEM

(75) Inventor: Vikram Vijaykumar INGLESHWAR, Solapur (IN)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/924,011

(22) Filed: Oct. 25, 2007

(30) Foreign Application Priority Data
Sep. 7, 2007 (IN) 2005/CHE/2007

(51) Int. Cl. G06Q 30/00

(52) U.S. Cl. 705/14

(57) ABSTRACT

A content generator (i.e., a user) provides an indication of the subject matter that is then usable for advertisement targeting. In accordance with an additional aspect, the user is rewarded when a reader of the content views or otherwise monetizes an advertisement that has been generated based on the user-provided indication. Furthermore, in some aspects, the more successful a user is at indicating subject matter, as determined by monetization of advertisements generated based on the subject matter indications, the higher that indicating user is ranked. Rewarding of that indicating user may be concomitantly increased.

### BACKGROUND

It is known to automatically scan web content and to display advertisements along with the content based on “keywords” found in the web page. Thus, for example, viewers of the web content can be targeted with advertisements that may be relevant to the web content based on the automated scanning.

### SUMMARY

In accordance with an aspect, a content generator (i.e., a user) provides an indication of the subject matter that is then usable for advertisement targeting. In accordance with an additional aspect, the user is rewarded when a reader of the content views or otherwise monetizes an advertisement that has been generated based on the user-provided indication. Furthermore, in some aspects, the more successful a user is at indicating subject matter, as determined by monetization of advertisements generated based on the subject matter indications, the higher that indicating user is ranked. Rewarding of that indicating user may be concomitantly increased.

In one example, an indication of at least one keyword associated with the content is received from an author of the content. At least one advertisement is determined at least in part by processing the received at least one provided keyword. The content is caused to be displayed to a viewing user in association with the at least one advertisement determined by processing the at least one keyword received from the author of the content.

Further, in some examples, based on receiving an indication that the viewing user has activated the at least one advertisement determined by processing the at least one keyword received from the author of the content, a ranking associated with the author of the content is adjusted. Furthermore, value may be provided to the author of the content further based at least in part on the ranking associated with the author of the content.

### BRIEF DESCRIPTION OF THE DRAWINGS

FIG. 1 is a block diagram illustrating the architecture of a network-based system in which a user may interact, via a network such as the internet, with a web site including content-authoring functionality, such as a web-based e-mail service to indicate keywords for the authored content.

FIG. 2 illustrates an example of a screen shot that may be presented to a user while the user is interacting with a web site to author content intended to be communicated with another user.

FIG. 3 illustrates another example of a screen shot that may be presented to a user while the user is interacting with a web site to author content intended to be communicated with another user.

FIG. 4 is a screen shot illustrating an example in which an interface includes both content-authoring functionality and content-viewing functionality.

FIG. 5 illustrates an example of a user rankings table maintained by a user ranking service.

FIG. 6 is a flowchart illustrating an example of a method to maintain the ranking for a particular user.

FIG. 7 is a flowchart illustrating an example of a method to author content and indicate keywords usable to generate relevant advertisements to viewers of the content by, for example, interacting with an e-mail composition screen.

FIG. 8 is a flowchart illustrating an example of a method to view content and, in addition, view advertisements displayed based at least in part on keywords indicated by the content author.

FIG. 9 is a simplified diagram of a network environment in which specific embodiments of the present invention may be implemented.

### DETAILED DESCRIPTION

The inventor has realized that, particularly for certain types of content, there are privacy concerns surrounding the practice of automated scanning of such content. One particular area of concern is with e-mail content, which tends to be of an especially sensitive nature. For example, this has been a concern with Google's gmail service. Furthermore, the automated scanning may not be able to adequately discern the subject matter of the content such that subsequently generated advertisements are likely to be useful to readers of the content.

In accordance with an aspect, a content generator (i.e., a user) provides an indication of the subject matter that is then usable for advertisement targeting. In accordance with an additional aspect, the user is rewarded when a reader of the content views or otherwise monetizes an advertisement that has been generated based on the user-provided indication. Furthermore, in some aspects, the more successful a user is at indicating subject matter, as determined by monetization of advertisements generated based on the subject matter indications, the higher that indicating user is ranked. Rewarding of that indicating user may be concomitantly increased.

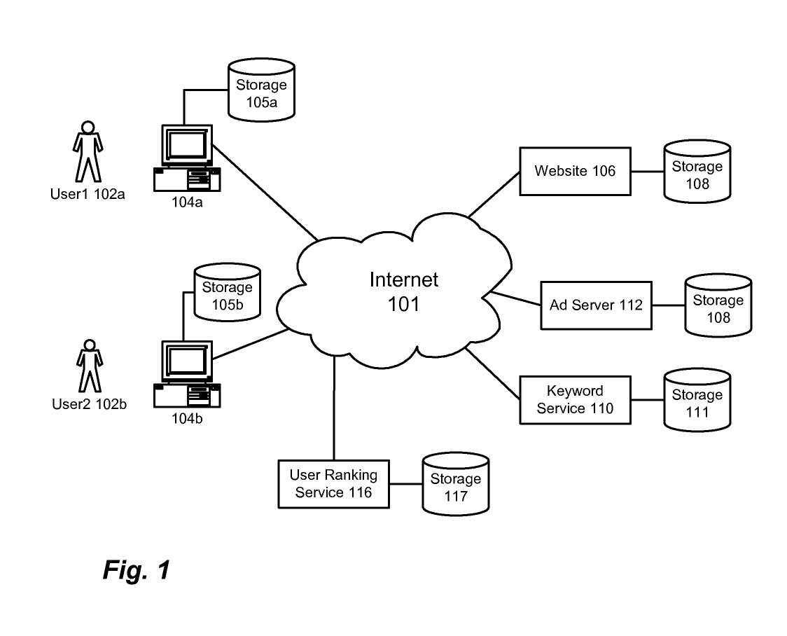

For example, FIG. 1 is a block diagram illustrating the architecture of a network-based system 100 in which a user1 102a (e.g., using client software such as a browser, operating on a computer 104a accessed from a computer-readable medium 105a) may interact, via a network 101 such as the internet, with a web site 106 including content-authoring functionality, such as a web-based e-mail service. More particularly, the user 102a may interact with the web site 106 (which is operating a web server program on a computer, from a computer readable medium 108) to author content intended to be communicated with another user, such as user2 102b (e.g., using client software such as a browser, operating on a computer 104b accessed from a computer-readable medium 105b). An example of a web-based e-mail service is the Yahoo! Mail service, although other web-based e-mail services are available as well. Furthermore, there are other web-based services that include content-authoring functionality, such as instant messenger services and even blogging services.

In other examples, some or all of the content-authoring functionality may be client-based (i.e., functionality provided by software executing on the computer 104a of user1 102a), and the corresponding server-based functionality may be provided primarily to transmit or publish the resulting authored content.

As will be described in more detail later, the content-authoring functionality (e.g., provided by the web site 106, via the functionality of the client computer 104a or a combination of both) interacts with a keyword service 110 (for example, operating according to a program in data storage 111) such that the user1 102a, in the process of interacting with the web site 106 to author content, via the software operating on the computer 104a, may also indicate keywords for the content, such as keywords that are ostensibly indicative, in the judgment of user1 102a, of the authored content. Similar to the discussion above regarding the content-authoring functionality, in some examples, the keyword service is provided as functionality partially or primarily of the client computer 104a.

The keyword indications may be stored in association with the authored content, for example. The keywords are usable by an advertisement service, alone or in conjunction with other factors and/or criteria, to determine one or more advertisements (from advertisement inventory 114) to associate with the authored content. The determined one or more advertisements are displayed to the user2 102b as the computer 104b operates to display the content, authored by the user 102a, to the user2 102b. As just some examples, the content may be displayed by the use of an e-mail reader (e.g., client-based, web-based or a combination of both), an instant messenger (e.g., client-based, web-based or a combination of both), blog readers, website viewers such as browsers, etc.

In some examples, a user may receive value for other users activating an advertisement displayed based on a keyword or keywords indicated by that user. For example, the user may receive money or monetary equivalent such as credit in the form of points to be used towards purchases, credit into a bank account, credit to a credit card, etc. In other examples, the user may receive virtual money or points to be used towards purchases in a virtual world. In yet other examples, the user may receive points merely to accumulate for the sake of accumulating them.

In one example, the system 100 also includes a user ranking service 116, configured (e.g., according to a program stored on data storage 117) to maintain user rankings for users such as user1 102a. The rankings may be maintained on data storage 117. The rankings may be used to control, at least in part, how actions (or non-actions) with respect to an advertisements affect the value received by (or not received by, or debited from) the user who indicated the keywords based on which the advertisement was generated. Thus, for example, a ranking may be indicative of how successful a user is at indicating keywords that result in other users activating the advertisement or advertisements displayed based on the indicated keywords.

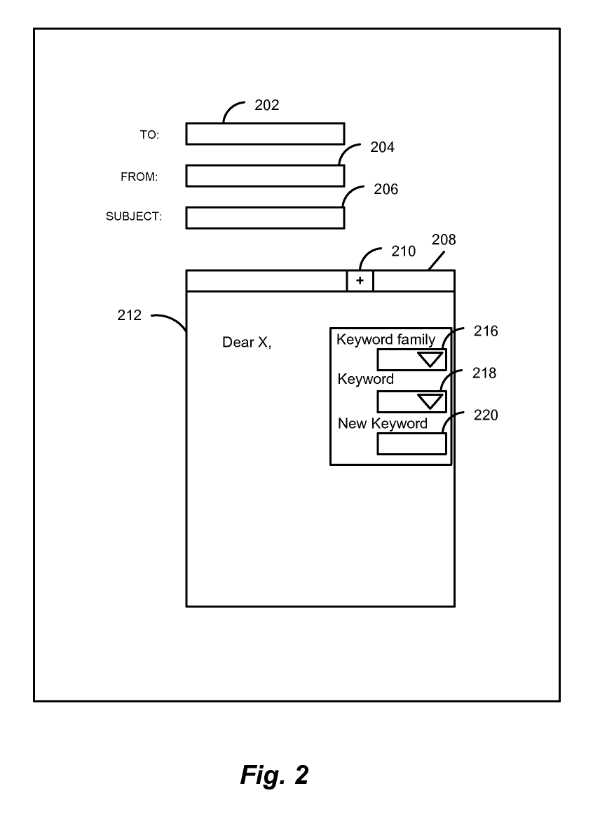

FIG. 2 illustrates an example of a screen shot that may be presented to a user such as user1 102a for the user 102a to author content intended to be communicated to another user. For example, as discussed above, the FIG. 2 screen shot may be presented the user as the user is interacting with the web site 106 (which is operating a web server program on a computer, from a computer readable medium 108) to author content intended to be communicated with another user. The FIG. 2 example screen includes areas usable for composing an e-mail, including a “from” field 202, a “to” field 204 and a “subject” field 206. The FIG. 2 example screen also includes a mail compose area 212.

In addition, a toolbar 208 area of the FIG. 2 screen includes an icon 210 that, when activated (e.g., by mouse click or otherwise), causes a pop-up dialog box 214 to be displayed by the keyword service 110. The user may indicate keywords to the keyword service 110 via the dialog box 214. In the FIG. 2 example screen, the user may interact with a pull-down menu in a portion 218 of the dialog box 214 to indicate a keyword. Or, instead, the user may indicate a keyword family if, for example, the user does not find an appropriate keyword in the pull-down menu in the portion 218 of the dialog box 214. As still another alternative, the user may enter an arbitrary keyword in the text field portion 220 of the dialog box 214.

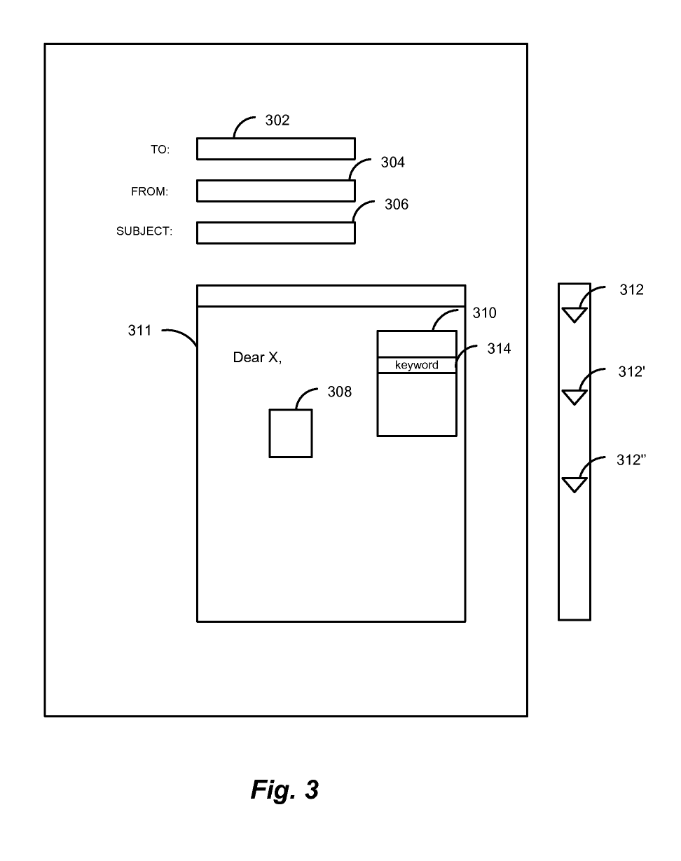

FIG. 3 illustrates another example of a screen shot that may be presented to a user such as user1 102a while the user 102a is author content intended to be communicated with another user (e.g., by interacting with the web site 106 operating a web server program on a computer, from a computer readable medium 108, as described above). The FIG. 3 example screen includes areas for composing an e-mail, including a “from” field 302, a “to” field 304 and a “subject” field 306. The FIG. 3 example screen also includes a mail compose area 312.

In accordance with the FIG. 3 example screen, a user control 312 is presented to the right of text presently being entered by the user in the mail compose area 311. The user may activate the user control 312 to cause a pop-up window 308 to be displayed. The user control 312 is caused to move down as the message is being input (e.g., typed), as indicated by the reference numerals 312′ and 312″. The pop-up window 308 may, for example, enable similar functionality as the dialog box 214 of the FIG. 2 example screen.

In some examples, in addition to or instead of the user control 312, a menu 310 may be caused to be displayed when a user right-clicks or otherwise activates a portion of the mail compose area 311. The menu 310 includes an option 314 for “add keyword” that, when activated, causes a pop-up window similar to the pop-up window 308 to be displayed.

Having described various examples of content-authoring functionality, we now describe some examples of content-viewing functionality that is complementary to the content-authoring functionality. An example of such content-viewing functionality includes e-mail inbox provided as part of an e-mail program. As discussed above, such a program may be operated from one or more server computers, a client computer or some combination of both. In accordance with some examples, the content-viewing interface itself is conventional, except that advertisements generated in the viewed content may have been generated based on keywords indicated by an authoring user. Additionally, the display of the content may include an indication to the viewing user that advertisements have been generated based on keywords chosen by the content author and that the mail provider is not reading the content.

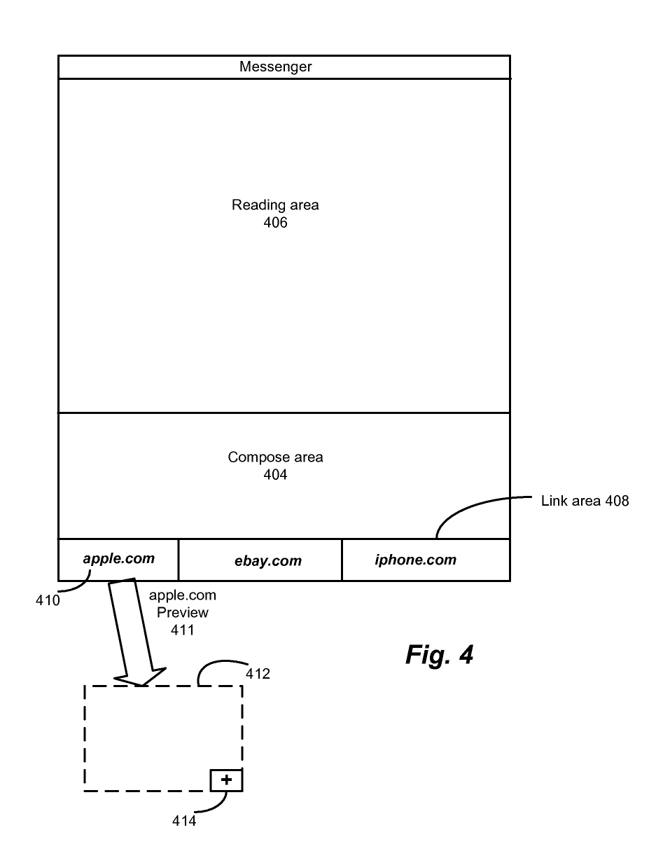

FIG. 4 is a screen shot illustrating an example in which an interface 402 is to both content-authoring functionality (in this example, a messenger compose area 404, such as for instant messaging) and content-viewing functionality (a messenger reading area 406). In the FIG. 4 screen shot, an “ad bar” 408 is shown. The ad bar 408 may be, for example, a scrolling bar, moving the advertisement indications from right to left, for example. In one example, activating an advertisement indication (such as “apple.com” 410) causes a preview window 412 to open. Activating a portion 414 of the preview window 412 may cause an actual advertisement to be displayed and the advertiser to be charged. This may be useful, for example, if the screen real estate is limited such as with a mobile phone, since the portion 414 of the preview window 412 ma be relatively small, but the actual advertisement may be larger.

We now discuss an example of the user ranking service 116. As mentioned above, a user ranking service 116 may be configured to maintain user rankings for users such as user1 102a. The rankings are indicative of how successful a user is at indicating keywords that result in other users activating the advertisement or advertisements displayed based on the indicated keywords. In some examples, the values a user receives for other users activating an advertisement displayed based on a keyword or keywords indicated by that user is based at least in part on a user ranking maintained for that user.

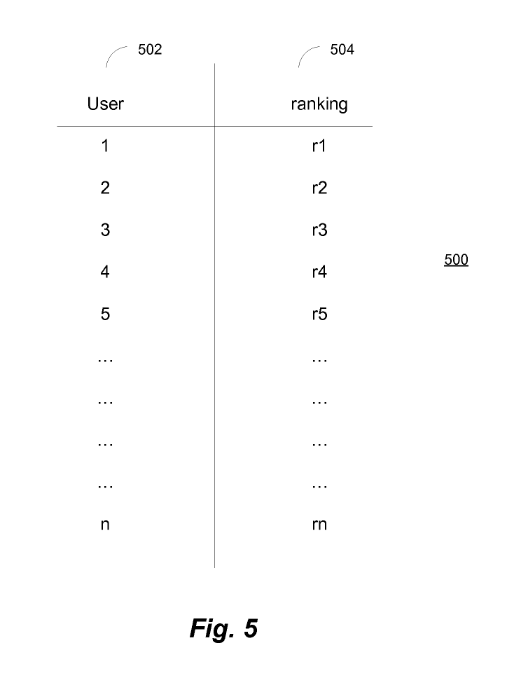

FIG. 5 illustrates an example of a user rankings table 500 maintained by a user ranking service. A first column 502 indicate users such as user1 102a and user2 102b. A second column 504 indicates a ranking for each user. The rankings may be used to, for example, at least in part determine a bonus to be provided to each user. The bonus may be in real or virtual money, points redeemable for products or services, or some other reward.

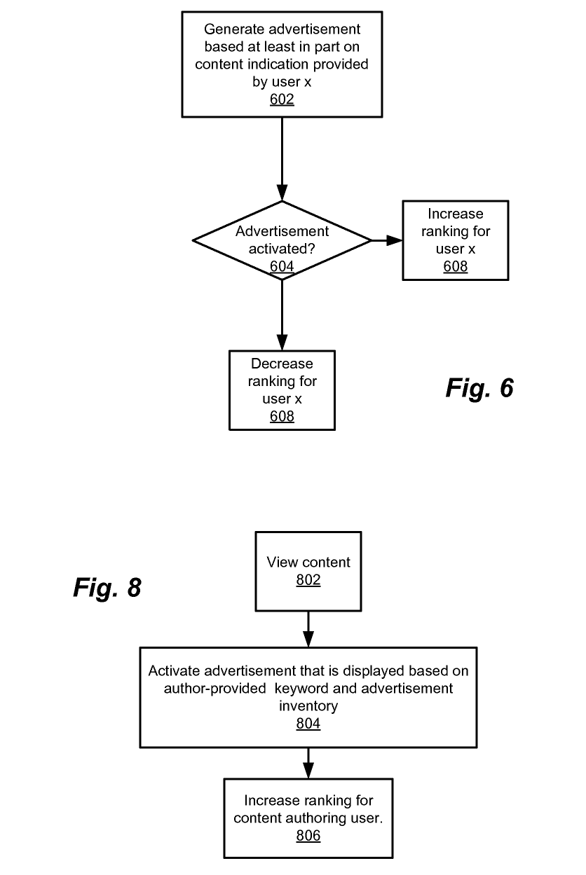

FIG. 6 is a flowchart illustrating an example of a method to maintain the ranking for a particular user. At 602, an advertisement is displayed to a content viewing user in conjunction with that user viewing the content. The advertisement is generated based on keywords indicated, such as described above, by a user who is the author of the viewed content. At 604, it is determined if the displayed advertisement has been activated. At 606, if it has been determined that the displayed advertisement has been activated, the ranking is increased for the user who authored the content. At 608, if it has been determined that the displayed advertisement has not been activated, the ranking is decreased for the user who authored the content.

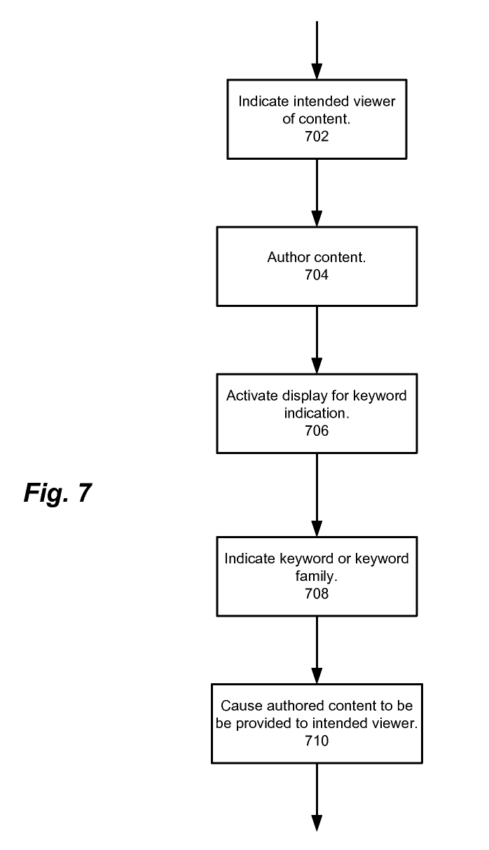

FIG. 7 is a flowchart illustrating an example of a method to author content and indicate keywords usable to generate relevant advertisements to viewers of the content by, for example, interacting with an e-mail composition screen. At 702, an indication of an intended viewer of the authored content is received from the authoring user (as indicated, for example, in the “To:” field of an e-mail. At 704, the content is received from the authoring user. At 706, a display is activated for keyword indication based on receiving an indication of an activation event from the authoring user. At 708, keyword indications are received from the authoring user and associated with the authored content. At 710, an indication of the authored content is caused to be provided to the intended viewer. As examples, such indication of the authored content may include a notification that e-mail is awaiting in the viewer's e-mail inbox, display of the authored content itself or other indications.

FIG. 8 is a flowchart illustrating an example of a method to view content and, in addition, view advertisements displayed based at least in part on keywords indicated by the content author. At 802, the content is presented to the viewing user indicated by the content author. At 804, an indication is received of an advertisement being activated by the viewing user. At 806, a ranking of the content author is increased based on the activation of the advertisement.

We have thus described systems and methods in which a content generator (i.e., a user) provides an indication of the subject matter of authored content, where the indication of the subject matter is then usable for advertisement targeting. In accordance with an additional aspect, the user is rewarded when a reader of the content views or otherwise monetizes an advertisement that has been generated based on the user-provided indication. Furthermore, in some aspects, the more successful a user is at indicating subject matter, as determined by monetization of advertisements generated based on the subject matter indications, the higher that indicating user is ranked. Rewarding of that indicating user may be concomitantly increased.

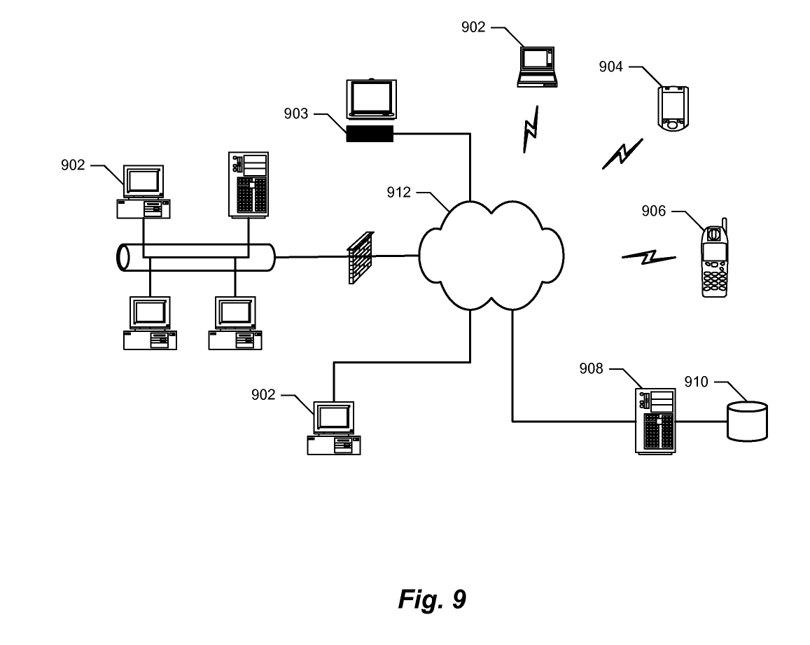

Embodiments of the present invention may be employed in any of a wide variety of computing contexts to provide supplemental material that is appropriate to a nominal expected retrieval and processing time and/or is appropriate to a nominal expected content of the processed specifications for mixing and matching data resulting from various web service calls s. For example, as illustrated in FIG. 9, implementations are contemplated in which users may interact with a diverse network environment via any type of computer (e.g., desktop, laptop, tablet, etc.) 902, media computing platforms 903 (e.g., cable and satellite set top boxes and digital video recorders), handheld computing devices (e.g., PDAs) 904, cell phones 906, or any other type of computing or communication platform.

According to various embodiments, applications may be executed locally, remotely or a combination of both. The remote aspect is illustrated in FIG. 9 by server 908 and data store 910 which, as will be understood, may correspond to multiple distributed devices and data stores.

The various aspects of the invention may also be practiced in a wide variety of network environments (represented by network 912) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A method of processing content, comprising:
receiving, from an author of the content, an indication of at least one keyword associated with the content;
determining at least one advertisement at least in part by processing the received at least one provided keyword; and
causing the content to be displayed to a viewing user in association with the at least one advertisement determined by processing the at least one keyword received from the author of the content.

2. The method of claim 1, further comprising:
based on receiving an indication that the viewing user has activated the at least one advertisement determined by processing the at least one keyword received from the author of the content, adjusting a ranking associated with the author of the content.

3. The method of claim 1, further comprising:
providing value to the author of the content based at least in part on the author of the content providing the at least one keyword.

4. The method of claim 3, further comprising:
based on receiving an indication that the viewing user has activated the at least one advertisement determined by processing the at least one keyword received from the author of the content, adjusting a ranking associated with the author of the content; and
providing value to the author of the content further based at least in part on the ranking associated with the author of the content.

5. The method of claim 1, wherein:
causing the content to be displayed to a viewing user in association with the at least one advertisement determined by processing the at least one keyword received from the author of the content includes
causing the content to be displayed in association with a preview of the advertisement; and
based on received an indication that the viewing user has activated the preview, causing the advertisement to be displayed.

6. The method of claim 1, further comprising:
causing to be displayed, to the author of the content, a keyword indication user interface element to facilitate indication of the at least one keyword by the author of the content;
wherein the indication of the at least one keyword is received via the keyword indication user interface element.

7. The method of claim 6, wherein:
the keyword indication user interface element facilitates indication of the at least keyword by the author of the content by suggesting possible keywords and receiving a choice of the suggested possible keywords as the indication of the at least one keyword.

8. The method of claim 6, wherein:
at least a portion of the keyboard indication user interface element is caused to be displayed to the content author in a vicinity of content currently being authored, such that as additional content is authored, the portion of the keyboard indication user interface element is displayed in the vicinity of the additional content.

9. A method of displaying advertisements in conjunction with content for viewing, wherein the content is provided for viewing via a communications network, comprising:
causing the content to be displayed for viewing on a display device of a computing device;
causing an indication of a preview of an advertisement to be displayed in conjunction with the content for viewing on the display device of the computing device;
in response to an activation of the preview of the advertisement by a user viewing the content, causing the advertisement to be displayed for viewing on the display device of the computing device; and
providing value to the author of the content.

10. The method of claim 9, wherein:
providing value to the author of the content is based at least in part on the author of the content providing at least one keyword based on which it is determined to cause the indication of the preview of the advertisement to be displayed.

11. A computing system including at least one computing device configured to process content by:
receiving, from an author of the content, an indication of at least one keyword associated with the content;
determining at least one advertisement at least in part by processing the received at least one provided keyword; and
causing the content to be displayed to a viewing user in association with the at least one advertisement determined by processing the at least one keyword received from the author of the content.

12. The computing system of claim 11, wherein the at least one computing device is further configured to:
based on receiving an indication that the viewing user has activated the at least one advertisement determined by processing the at least one keyword received from the author of the content, adjust a ranking associated with the author of the content.

13. The computing system of claim 11, wherein the at least one computing device is further configured to:
provide value to the author of the content based at least in part on the author of the content providing the at least one keyword.

14. The computing system of claim 13, wherein the at least one computing device is further configured to:
based on receiving an indication that the viewing user has activated the at least one advertisement determined by processing the at least one keyword received from the author of the content, adjust a ranking associated with the author of the content; and
provide value to the author of the content further based at least in part on the ranking associated with the author of the content.

15. The computing system of claim 11, wherein:
causing the content to be displayed to a viewing user in association with the at least one advertisement determined by processing the at least one keyword received from the author of the content includes
causing the content to be displayed in association with a preview of the advertisement; and
based on received an indication that the viewing user has activated the preview, causing the advertisement to be displayed.

16. The computing system of claim 11, wherein the at least one computing device is further configured to:
cause to be displayed, to the author of the content, a keyword indication user interface element to facilitate indication of the at least one keyword by the author of the content;
wherein the indication of the at least one keyword is received via the keyword indication user interface element.

17. The computing system of claim 16, wherein:
the keyword indication user interface element is configured to facilitate indication of the at least keyword by the author of the content by suggesting possible keywords and receiving a choice of the suggested possible keywords as the indication of the at least one keyword.

18. The computing system of claim 16, wherein:
at least a portion of the keyboard indication user interface element is caused to be displayed to the content author in a vicinity of content currently being authored, such that as additional content is authored, the portion of the keyboard indication user interface element is displayed in the vicinity of the additional content.

19. A computing system including at least one computing device configured to display advertisements in conjunction with content for viewing, wherein the content is provided for viewing via a communications network, the at least one computing device configured to:
cause the content to be displayed for viewing on a display device of the computing system;
cause an indication of a preview of an advertisement to be displayed in conjunction with the content for viewing on the display device of the computing system;
in response to an activation of the preview of the advertisement by a user viewing the content, causing the advertisement to be displayed for viewing on the display device of the computing system; and
providing value to the author of the content.

20. The computing system of claim 19, wherein the at least one computing device is further configured to:
provide value to the author of the content is based at least in part on the author of the content providing at least one keyword based on which it is determined to cause the indication of the preview of the advertisement to be displayed.
